(19) United States
(12) Patent Application Publication
(10) Pub. No.: US 2007/0014665 A1
(43) Pub. Date: Jan. 18, 2007

(54) Process and apparatus for manufacturing a connection and stress transmission element by overinjection

(75) Inventor: Agustin Morales Arnaez, Getxo (ES)

Correspondence Address: MERCHANT & GOULD PC, P.O. BOX 2903, MINNEAPOLIS, MN, 55402-0903, US

(73) Assignee: INDUSTRIA AUXILIAR ALAVESA, S.A., Amurrio (Alava) (ES)

(21) Appl. No.: 11/451,640

(22) Filed: Jun. 13, 2006

(30) Foreign Application Priority Data
Jun. 14, 2005 (EP) 05380127.0

(51) Int. Cl. B64C 27/50

(52) U.S. Cl. 416/134 A

(57) ABSTRACT

A connection and stress transmission element for automotive vehicle mechanisms, the apparatus and the process for manufacturing the joining element by ovreinjection. The joining element has a central portion (1) and a first end portion (2). The central portion (1) is of a material providing mechanical resistance and is bar-shaped, having a first end and a second end. The first end portion (2) is of plastic material overinjected on the first end such that the central portion (1) and the first end portion (2) form an single-piece joining element. The apparatus has: containing devices (100) to define a cavity (110) between the surface to be overinjected and the containing devices (100); input devices (200) and output devices (300) in the containing devices (100) so that the ovreinjection product is introduced in and extracted from the cavity (110).

### FIELD OF THE INVENTION

The invention falls within the field of automotive vehicle part manufacturing processes, particularly a process for manufacturing the parts related to connection and stress transmission elements, especially for suspension and steering mechanisms and the like in automotive vehicles, by overinjection. The invention also refers to an apparatus for manufacturing said parts and to the parts manufactured by said process.

### BACKGROUND OF THE INVENTION

Traditional processes use rigid equipment in which injection in the cavities is performed at variable pressures and temperatures, having a subsequent cooling or crystallising time with part ejecting devices in the mould opening. This rigid equipment does not prevent the parts from being generated with shape defects due to shrinkage occurring after injection, while inside the mould. For example, in the case that the part is ring-shaped, the shrinkage causes an out-of-roundness.

Several rigid axle suspension systems for vehicles are known in the art such as those disclosed in documents EP0776275, EP0783415, EP1077819, and EP1147023, and steering systems such as that disclosed in EP1329642.

### DESCRIPTION OF THE INVENTION

As well as avoiding the defects present in the state of the art mentioned above, the present invention describes a process and a manufacturing apparatus greatly reducing costs since the moulding is performed by a single injection whereas with traditional processes injection is performed on several occasions. This reduction in manufacturing costs also logically affects the cost of the final manufactured product, that is, the joining element.

Another differentiating feature of the present invention regarding the state of the art occurs with the part or mould holding carriages, which in the present invention are mobile; in contrast, the holding carriages in known apparatuses are fixed. Mobility of the part holding carriage allows compensating for plastic compressions.

The process of the invention also allows the element manufactured by means of said process to contain an overinjection product having a series of advantages over those known in the state of the art. Among these, the overinjection product is a material having a semi-crystalline structure with a low coefficient of friction on metals and plastics, about 10 times less than those known, and a low abrasion level.

Structural plastics have reinforcing fillers which abrade the material providing mechanical resistance to the joining element, which may be of steel. The invention allows using plastics without reinforcing fillers and which therefore do not wear the steel, making the useful life of a part of the invention 100 times that of a conventional part.

After stating some of the advantages provided by the present invention, the same is now described.

A first aspect of the invention refers to a process for manufacturing by overinjection:
a connection and stress transmission element for automotive vehicle suspension and steering mechanisms comprising:
   a bar-shaped central portion:
      having a first end and a second end;
      of a material providing mechanical resistance;
   a first end portion of plastic material overinjected on the first end so that the central portion and the first end portion form a single-piece joining element;
by means of an apparatus for overinjecting an overinjection product on a central portion of a joining element having a surface to be overinjected in order to obtain a joining element, said apparatus comprising:
   containing means configured to define a cavity between the surface to be overinjected and said containing means;
   inlet means located in the containing means so as to allow the overinjection product to be introduced in the cavity;
   outlet means located in the containing means so as to allow the overinjection product to be extracted from the cavity;
characterised in that said process comprises the steps of:
   i) placing the central portion in a central mould;
   ii) placing a first side mould opposite to the first end;
   iii) shifting the central mould and the first side mould to an overinjection position in which the two moulds make up the containing means and define a cavity in which an overinjection product is injected to make up the first end portion of plastic material on the central portion;
   iv) shifting the central mould and the first side mould up to a mould release position in which the single-piece joining element is extracted.

A second aspect of the invention refers to a process for manufacturing by overinjection
a connection and stress transmission element for automotive vehicle suspension and steering mechanisms comprising:
   a bar-shaped central portion:
      having a first end and a second end;
      of a material providing mechanical resistance;
   a first end portion of plastic material overinjected on the first end so that the central portion and the first end portion form a single-piece joining element;
by means of an apparatus for overinjecting an overinjection product on a central portion of a joining element having a surface to be overinjected in order to obtain a joining element, said apparatus comprising:
   containing means configured to define a cavity between the surface to be overinjected and said containing means;
   inlet means located in the containing means so as to allow the overinjection product to be introduced in the cavity;
   outlet means located in the containing means so as to allow the overinjection product to be extracted from the cavity;
characterised in that said process comprises the steps of:
   i) placing the central portion in a central mould;
   ii) placing a first side mould opposite to the first end;
   iii) placing an auxiliary mould opposite to the second end;
   iv) shifting the central mould, the first side mould and the auxiliary mould to an overinjection position in which the three moulds make up the containing means and define a cavity in which an overinjection product is overinjected in order to make up the first end portion of plastic material on the central portion;
   v) shifting the central mould, the first side mould and the auxiliary mould to a mould release position in which the single-piece joining element is extracted.

A third aspect of the invention refers to a process for manufacturing by overinjection
a connection and stress transmission element for automotive vehicle suspension and steering mechanisms comprising:
   a bar-shaped central portion:
      having a first end and a second end;
      of a material providing mechanical resistance;
   a first end portion of plastic material overinjected on the first end;
   a second end portion of plastic material overinjected on the second end so that the central portion, the first end portion and the second end portion form a single-piece joining element;
by means of an apparatus for overinjecting an overinjection product on a central portion of a joining element having a surface to be overinjected in order to obtain a joining element, said apparatus comprising:
   containing means configured to define a cavity between the surface to be overinjected and said containing means;
   inlet means located in the containing means so as to allow the overinjection product to be introduced in the cavity;
   outlet means located in the containing means so as to allow the overinjection product to be extracted from the cavity;
characterised in that said process comprises the steps of:
   i) placing the central portion in a central mould;
   ii) placing a first side mould opposite to the first end;
   iii) placing a second side mould opposite to the second end;
   iv) shifting the central mould, the first side mould and the second side mould to an overinjection position in which the three moulds make up the containing means and define a cavity in which an overinjection product is overinjected in order to make up the first end portion of plastic material and the second end portion of plastic material on the central portion;
   v) shifting the central mould, the first side mould and the second side mould to a mould release position in which the single-piece joining element is extracted.

The process according to the first aspect of the invention contemplates that the geometry of the central mould prevents the use of an auxiliary mould from being necessary; this alternative of using an auxiliary mould is considered in the second aspect of the invention; similarly, the possibility of using a second side mould is contemplated according to the third aspect of the invention.

On the other hand, according to any of the first, second and third aspects of the invention, the possibility that any of the inlet means, outlet means, connecting means, pressure measuring means, and temperature measuring means may be located in any of the central mould, the first side mould, the auxiliary mould and the second side mould, is also contemplated.

Another approach for the first, second and third aspects of the invention, which will be called first′, second′ and third′ aspects, would be that included below.

The first′ aspect of the invention refers to a process for manufacturing a joining element by overinjection by means of the apparatus described above comprising the steps of:
i′) placing the central portion in a central mould;
ii′) placing a first side mould opposite to the first end;
iii′) shifting said moulds to an injection moulding position in which the moulds make up the containing means and define a cavity in which an overinjection product is overinjected to make up the first end portion of plastic material on the central portion;
iv′) shifting the moulds to a mould release position in which the single-piece joining element is extracted.

According to the second′ or third′ aspects of the invention, the process may also comprise, respectively, one of the following steps:
ii′a)placing an auxiliary mould opposite to the second end;
ii′b)placing a second side mould opposite to the second end.

The processes of the invention may further comprise the following supplementary steps:
a) generating a vacuum in the cavity through connecting means by means of vacuum generating means;
b) introducing the overinjection product in the cavity through inlet means by means of introduction means;
c) generating overpressure in the cavity through connecting means by means of overpressure generating means in order to obtain a single-piece joining element comprising at least a first end portion;
d) extracting the excess overinjection product from the cavity through outlet means by means of extraction means.

The vacuum generating step a) may comprise:
a1) reaching a first pressure P1 comprised between 2500 Pa and 25 kPa in the cavity during a first time t1 comprised between 1 s and 120 s;
a2) ending step a) with a second pressure P2 comprised between 2500 Pa and 25 kPa in the cavity during a second time t2 comprised between 1 s and 120 s.

The processes of the invention may further comprise a prior substep a0) in order to reach a prior temperature T0 comprised between 20° C. and 120° C. in the central portion to be overinjected.

The overinjection material input step b) may comprise:
b1) introducing said material in the cavity which is at a first temperature T1 comprised between 100° C. and 400° C. during a third time t3 comprised between 1 s and 120 s;
b2) ending step b) with a third pressure P3 comprised between 2 MPa and 100 MPa in the cavity during a fourth time t4 comprised between 1 s and 120 s.

The overpressure generation step c) may comprise:
c1) starting with a fourth pressure P4 comprised between 2 MPa and 100 MPa in the cavity during a fifth time t5 comprised between 1 s and 120 s;
c2) ending step c) with a fifth pressure P5 comprised between 2 MPa and 100 MPa in the cavity.

In the processes of the invention, extraction step d) may last a sixth time t6 comprised between 1 s and 120 s.

The processes of the invention may further comprise a prior drying step for drying the surface to be overinjected. The prior drying step may comprise reaching a drying temperature T′0 comprised between 20° C. and 150° C. on the surface to be overinjected upon for a drying time t′0 comprised between 1 s and 120 s.

The process of the invention also contemplates subsequently curing the overinjected surface. The curing step may comprise reaching a subsequent temperature Tn comprised between 20° C. and 150° C. in the overinjected surface during a subsequent time comprised between 1 s and 120 s.

A fourth aspect of the invention refers to a connection and stress transmission element for automotive vehicle suspension and steering mechanisms manufactured by means of the aforementioned process in which the overinjected product is a material having:
a semi-crystalline structure;
a low coefficient of friction on metals and plastics; the coefficient of friction on structural plastics is 10, whereas the invention allows using plastics with a coefficient of friction of 1;
a low abrasion level; structural plastics have reinforcing fillers which abrade steel, whereas the invention allows using plastics without reinforcing fillers and therefore they do not wear the steel, which makes the useful life of a part of the invention 100 times that of a conventional part.

The overinjection product in the joining element may be a material selected from: polyamides, polyesters, monoacetals, polyacetals and mixtures thereof.

At least one end portion in the joining element may comprise a device selected from a ball socket and a ring configured to house fixing means. Said fixing means may comprise a device selected from a bushing, a silent-block and combinations thereof.

The central portion of the joining element of the invention may have a shape selected from a notably straight shape, an angled shape, a U shape and a C shape.

A fifth aspect of the invention refers to an apparatus for manufacturing the joining element by overinjection by means of the process described above, in which the apparatus may further comprise coupling means for:
coupling the containing means to the surface to be overinjected;
assuring leak-tightness between the containing means and the surface to be overinjected, adapting the shape of the containing means to the surface to be overinjected.

The apparatus of the invention may also comprise connecting means located in the containing means so as to allow a pressure selected from vacuum pressure, ambient pressure and overpressure to be generated in the cavity.

The apparatus may additionally incorporate:
pressure measuring means located in the containing means to measure pressure in the cavity;
temperature measuring means located in the containing means to measure temperature in the cavity.

On the other hand, the inlet means and outlet means in the apparatus of the invention may be formed in a single element.

The apparatus may further comprise:
introduction means to introduce the overinjection product in the cavity through the inlet means;
extraction means to extract the overinjection product in the cavity through the outlet means.

The apparatus of the invention may further comprise:
vacuum generating means to generate a vacuum pressure in the cavity through the connecting means;
overpressure generating means to generate an overpressure in the cavity through the connecting means.

### BRIEF DESCRIPTION OF THE DRAWINGS

A set of drawings is briefly described below aiding to better understand the invention and specifically related to an embodiment of said invention, presented as a non-limiting example thereof.

FIG. 1 shows a sectional plan view of the apparatus of the invention showing a single-piece joining element of the invention.

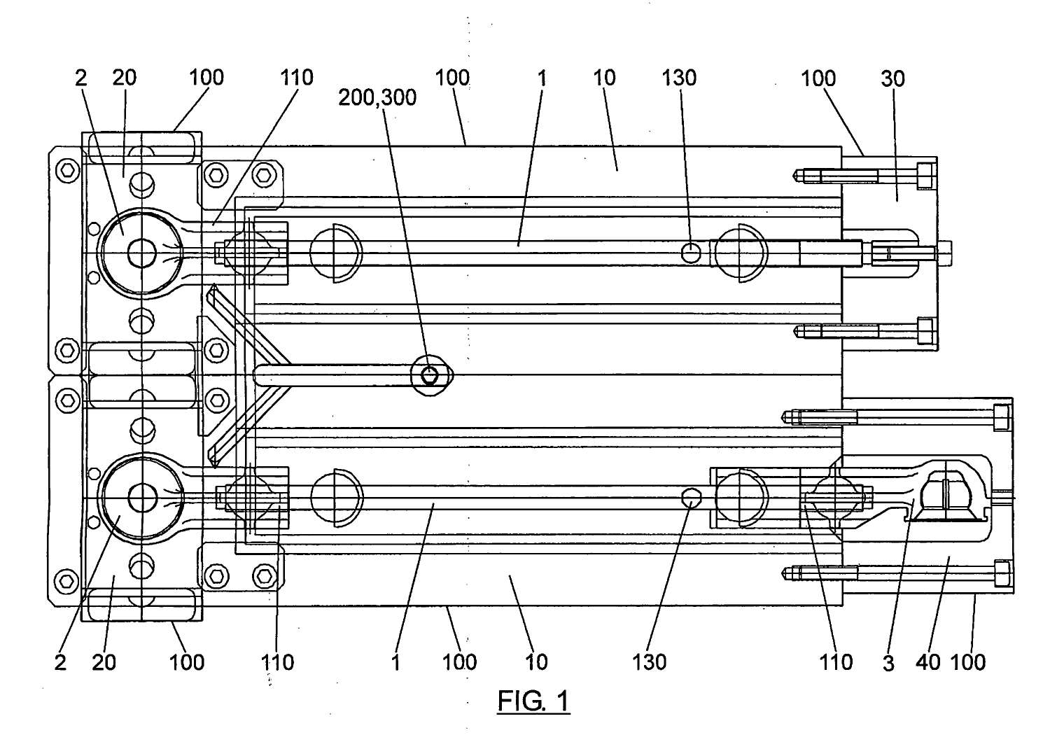

FIG. 2 shows a sectional side view of the apparatus of the invention. FIGS. 1 and 2 show an embodiment in which the apparatus of the invention is made up of a multiple mould.

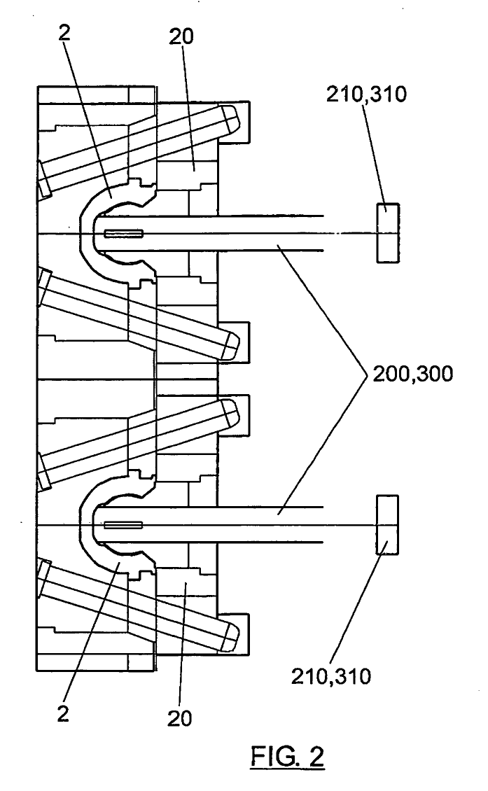

FIG. 3 shows a sectional elevational view of the apparatus of the invention showing an single-piece joining element of the invention.

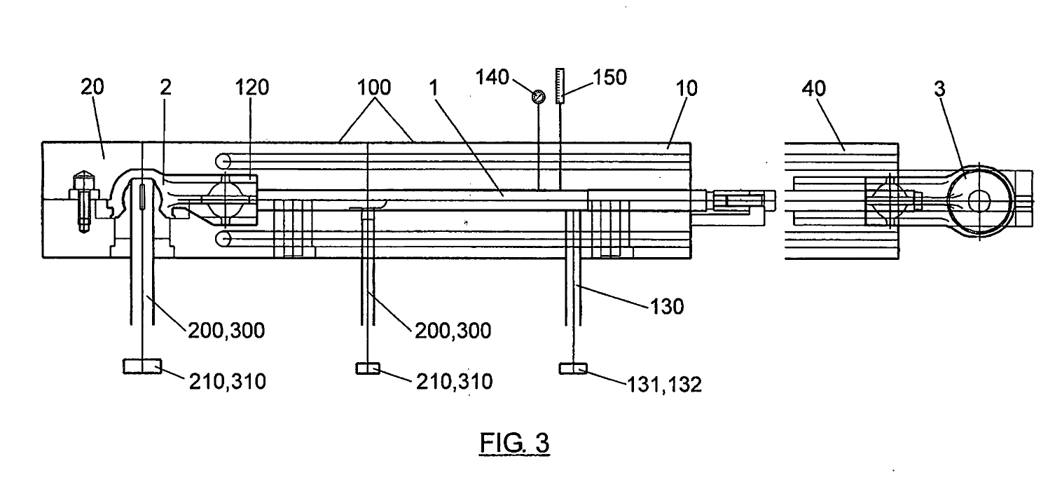

### DETAILED DESCRIPTION OF AN EMBODIMENT OF THE INVENTION

A first embodiment of the invention refers to a process for manufacturing a connection and stress transmission element for automotive vehicle suspension and steering mechanisms by overinjection, comprising:
a central portion 1:
   in the form of a bar having a first end and a second end;
   of a material providing mechanical resistance;
a first end portion 2 of plastic material overinjected on the first end so that the central portion 1 and the first end portion 2 form a single-piece joining element.

The process is carried out by means of an apparatus for overinjecting an overinjection product on a central portion 1 of a joining element having a surface to be overinjected in order to obtain a joining element, said apparatus comprising:
containing means 100 configured to define a cavity 110 between the surface to be overinjected and said containing means 100;
inlet means 200 located in the containing means 100 so as to allow the overinjection product to be introduced in the cavity 110;
outlet means 300 located in the containing means 100 so as to allow the overinjection product to be extracted from the cavity 110.

The process carried out comprises the steps of:
i) placing the central portion 1 in a central mould 10; at least one area of the central portion 1 will not be overinjected, said area therefore being exposed; the central portion 1 is held by the central mould 10 in this non-overinjected area;
ii) placing a first side mould 20 opposite to the first end;
iii) shifting the central mould 10 and the first side mould 20 to an overinjection position in which the two moulds make up the containing means 100 and define a cavity 110 in which an overinjection product, such as a plastic material, is overinjected to make up the first end portion 2 on the central portion 1; the overinjection product is assured to reach all the areas to be overinjected in this overinjection position;
iv) shifting the central mould 10 and the first side mould 20 to a mould release position in which the single-piece joining element is extracted.

The outlet means 300 may be configured so that the excess overinjection product found in the conduits of the containing means 100 feeding the overinjection product from the inlet means 200 to the cavity 110 is extracted in the mould release position.

A second embodiment of the invention refers to a connection and stress transmission element for automotive vehicle suspension and steering mechanisms manufactured by means of the process described above. In said joining element the ovreinjection product is a material having:
a semi-crystalline structure;
a low coefficient of friction on metals and plastics;
a low abrasion level.

A third embodiment of the invention refers to an apparatus for manufacturing the joining element by means of the process described above, in which said apparatus further comprises coupling means 120 for:
coupling the containing means 100 to the surface to be overinjected;
assuring leak-tightness between the containing means 100 and the surface to be overinjected, adapting the shape of the containing means 100 to the surface to be overinjected.

1. A process for manufacturing a connection and stress transmission element for automotive vehicle suspension and steering mechanisms by overinjection, comprising:
a bar-shaped central portion:
having a first end and a second end;
of a material providing mechanical resistance;
a first end portion of plastic material which is overinjected on the first end so that the central portion and the first end portion form a single-piece joining element;
by means of an apparatus for overinjecting an overinjection product on a central portion of a joining element having a surface to be overinjected so as to obtain a joining element, said apparatus comprising:
containing means configured to define a cavity between the surface to be voerinjected and said containing means;
inlet means located in the containing means so as to allow the overinjection product to be introduced in the cavity;
outlet means located in the containing means so as to allow the overinjection product to be extracted from the cavity;
wherein said process comprises the steps of:
i) placing the central portion in a central mould;
ii) placing a first side mould opposite to the first end;
iii) shifting the central mould and the first side mould to an overinjection position in which the two moulds make up the containing means and define a cavity in which an overinjection product is overinjected to make up the first end portion of plastic material on the central portion;
iv) shifting the central mould and the first side mould to a mould release position in which the single-piece joining element is extracted.

2. A process for manufacturing a connection and stress transmission element for automotive vehicle suspension and steering mechanisms by overinjection, comprising:
a bar-shaped central portion:
having a first end and a second end;
of a material providing mechanical resistance;
a first end portion of plastic material which is overinjected on the first end so that the central portion and the first end portion form a single-piece joining element;
by means of an apparatus for overinjecting an overinjection product on a central portion of a joining element having a surface to be overinjected so as to obtain a joining element, said apparatus comprising:
containing means configured to define a cavity between the surface to be overinjected and said containing means;
inlet means located in the containing means so as to allow the overinjection product to be introduced in the cavity;
outlet means located in the containing means so as to allow the overinjection product to be extracted from the cavity;
wherein said process comprises the steps of:
i) placing the central portion in a central mould;
ii) placing a first side mould opposite to the first end;
iii) placing an auxiliary mould opposite to the second end;
iv) shifting the central mould, the first side mould and the auxiliary mould to an overinjection position in which the three moulds make up the containing means and define a cavity in which an overinjection product is overinjected in order to make up the first end portion of plastic material on the central portion;
v) shifting the central mould, the first side mould and the auxiliary mould to a mould release position in which the single-piece joining element is extracted.

3. A process for manufacturing a connection and stress transmission element for automotive vehicle suspension and steering mechanisms by overinjection, comprising:
a bar-shaped central portion:
having a first end and a second end;
of a material providing mechanical resistance;
a first end portion of plastic material which is overinjected on the first end;
a second end portion of plastic material which is overinjected on the second end so that the central portion, the first end portion and the second end portion form a single-piece joining element;
by means of an apparatus for overinjecting an overinjection product on a central portion of a joining element having a surface to be overinjected so as to obtain a joining element, said apparatus comprising:
containing means configured to define a cavity between the surface to be overinjected and said containing means;
inlet means located in the containing means so as to allow the overinjection product to be introduced in the cavity;
outlet means located in the containing means so as to allow the overinjection product to be extracted from the cavity;
wherein said process comprises the steps of:
i) placing the central portion in a central mould;
ii) placing a first side mould opposite to the first end;
iii) placing a second side mould opposite to the second end;
iv) shifting the central mould, the first side mould and the second side mould to an overinjection position in which the three moulds make up the containing means and define a cavity in which an overinjection product is overinjected in order to make up the first end portion of plastic material and the second end portion of plastic material on the central portion;
v) shifting the central mould, the first side mould and the second side mould to a mould release position in which the single-piece joining element is extracted.

4. The process of claim 1, wherein while in the overinjection position the process further comprises the steps of:
a) generating a vacuum in the cavity through connecting means by means of vacuum generating means;
b) introducing the overinjection product in the cavity through inlet means by means of introducing means;
c) generating overpressure in the cavity through connecting means by means of overpressure generating means so as to obtain a single-piece joining element comprising at least a first end portion;
d) extracting the excess overinjection product from the cavity through outlet means by means of extracting means.

5. The process of claim 4 wherein the vacuum generating step a) comprises:
a1) reaching a first pressure P1 comprised between 2500 Pa and 25 kPa in the cavity during a first time t1 comprised between 1 s and 120 s;
a2) ending step a) with a second pressure P2 comprised between 2500 Pa and 25 kPa in the cavity during a second time t2 comprised between 1 s and 120 s.

6. The process of claim 4, wherein it further comprises a prior substep a0) so as to reach a prior temperature T0 comprised between 20° C. and 120° C. in the central portion to be overinjected.

7. The process of claim 4, wherein the overinjection material introduction step b) comprises:
b1) introducing said material in the cavity, which is at a first temperature T1 comprised between 100° C. and 400° C. during a third time t3 comprised between 1 s and 120 s;
b2) ending step b) at a third pressure P3 comprised between 2 MPa and 100 MPa in the cavity during a fourth time t4 comprised between 1 s and 120 s.

8. The process of claim 4, wherein the overpressure generation step c) comprises:
c1) starting at a fourth pressure P4 comprised between 2 MPa and 100 MPa in the cavity during a fifth time t5 comprised between 1 s and 120 s;
c2) ending step c) at a fifth pressure P5 comprised between 2 MPa and 100 MPa in the cavity.

9. The process of claim 4, wherein the extraction step d) lasts a sixth time t6 comprised between 1 s and 120 s.

10. The process of claim 4, wherein it further comprises previously drying the surface to be overinjected.

11. The process of claim 10 wherein the preceding drying step comprises reaching a drying temperature T′0 comprised between 20° C. and 150° C. in the surface to be overinjected during a drying time t′0 comprised between 1 s and 120 s.

12. The process of claim 4, wherein it further comprises subsequently curing the overinjected surface.

13. The process of claim 12 wherein the curing step comprises reaching a subsequent temperature Tn comprised between 20° C. and 150° C. in the overinjected surface during a subsequent time comprised between 1 s and 120 s.

14. A connection and stress transmission element for automotive vehicle suspension and steering mechanisms manufactured by means of the process of claim 1, wherein the overinjection product is a material having:
a semi-crystalline structure;
a low friction coefficient on metals and plastics; and
a low abrasion level.

15. The joining element of claim 14, wherein the overinjection product is a material selected from: polyamides, polyesters, monoacetals, polyacetals and mixtures thereof.

16. The joining element of claim 14, wherein at least one end portion comprises a device selected from a ball socket and a ring configured to house fixing means.

17. The joining element of claim 16, wherein the fixing means comprise a device selected from a bushing, a silent-block and combinations thereof.

18. The joining element of claim 14, wherein the central portion has a shape selected from a substantially straight-shaped, angled-shaped, U-shaped and C-shaped.

19. An apparatus for manufacturing the joining element of a connection and stress transmission element for an automotive vehicle suspension and steering mechanism, including an overinjected portion, wherein the overinjection product is a material having:
a semi-crystalline structure;
a low friction coefficient on metals and plastics; and
a low abrasion level;
and wherein said apparatus further comprises coupling means for:
coupling a containing means to a surface to be overinjected; and
assuring leak-tightness between the containing means and the surface to be overinjected, adapting the shape of the containing means to the surface to be overinjected.

20. The apparatus of claim 19, further comprising connecting means located in the containing means to allow a pressure selected from a vacuum pressure and an overpressure to be generated in the cavity.

21. The apparatus of claim 19, further comprising:
pressure measuring means located in the containing means to measure pressure in the cavity;
temperature measuring means located in the containing means to measure temperature in the cavity.

22. The apparatus of claim 19, wherein the inlet means and the outlet means are formed in a single element.

23. The apparatus of claim 19, further comprising:
introducing means to introduce the overinjection product in the cavity through the inlet means;
extracting means to extract the overinjection product from the cavity through the outlet means.

24. The apparatus of claim 19, further comprising:
vacuum generating means for generating a vacuum pressure in the cavity through the connecting means;
overpressure generating means for generating an overpressure in the cavity through the connecting means.
